(19) United States
(12) Patent Application Publication
(10) Pub. No.: US 2024/0385427 A1
(43) Pub. Date: Nov. 21, 2024

(54) Space Telescope and Method for Calibrating a Space Telescope in Space

(71) Applicant: Deutsches Zentrum für Luft- und Raumfahrt e.V., Bonn (DE)

(72) Inventor: Andreas Eckardt, Berlin (DE)

(73) Assignee: Deutsches Zentrum für Luft- und Raumfahrt e.V., Bonn (DE)

(21) Appl. No.: 18/693,992

(22) PCT Filed: Sep. 9, 2022
(86) PCT No.: PCT/EP2022/075080

§ 371 Date: Mar. 21, 2024

(30) Foreign Application Priority Data
Sep. 30, 2021 (DE) 10 2021 210 970.5

(51) Int. Cl. G02B 23/02; G02B 26/08

(52) U.S. Cl. CPC G02B 23/02; G02B 26/0816

(57) ABSTRACT

A space telescope comprising a primary mirror, a secondary mirror, an image field corrector, a focal plane with at least one optical sensor and an evaluation unit for the data from the optical sensor, the focal plane being assigned at least one actuating unit, the at least one actuating unit being designed to displace the focal plane in the X- and Y-directions, the secondary mirror being assigned at least one further actuating unit, the at least one further actuating unit being designed to displace the secondary mirror in the Z-direction, the actuating unit further being designed to ensure a reproducible adjustment of at least 1 nm over at least one pixel length of the optical sensor, with the Z-direction being parallel to the optical axis of the space telescope, and to a method for calibrating a space telescope in space.

### BACKGROUND OF THE INVENTION

### 1. Field of the Invention

The invention relates to a space telescope and to a method for calibrating a space telescope in space.

### 2. Brief Description of the Related Art

Space telescopes which track the focus of the instrument in the imaging with the aid of one or more mechanisms are known. These mechanisms can carry out the tracking both rapidly and slowly. Current space telescopes operate with the assumption that the design is tailored to a specific orbit with regard to the thermal conditions. Furthermore, a very accurate transfer function between the primary and secondary mirrors is determined elaborately. One problem is that it is necessary to compensate for any drifts of the AOCS system (Attitude and Orbit Control System), the regulating accuracy of which is only sufficient on average. Another problem is that the calibrations are often carried out under the effect of gravity on the Earth.

### SUMMARY OF THE INVENTION

The technical object of the invention is to propose a space telescope which can be calibrated or recalibrated in space, and to provide a suitable method for calibrating a space telescope in space.

To this end, the space telescope comprises a primary mirror, a secondary mirror, an image field corrector, a focal plane having at least one optical sensor, and an evaluation unit for the data of the optical sensor. The focal plane is in this case assigned at least one actuating unit, the at least one actuating unit being configured in such a way as to displace the focal plane in the X and Y directions, the secondary mirror being assigned at least one further actuating unit, which is configured in such a way as to displace the secondary mirror in the Z direction, the actuating unit furthermore being configured in such a way as to ensure a reproducible adjustment of less than or equal to 1 nm over at least one pixel length of the optical sensor, the Z direction being parallel to the optical axis of the space telescope. The actuating units preferably comprise piezo actuating elements, by means of which readjustment can be carried out with high accuracy. The focus, which represents a crucial quantity for the optical quality of the space telescope, can be adjusted very accurately by means of the actuating unit for the secondary mirror. The distance between the primary and secondary mirrors is in this case varied in increments of less than or equal to 1 nm, the imaging quality in each case being assessed by the evaluation unit. A Z setting in which the imaging quality has a maximum is in this case sought. Subsequently, the focal plane is then displaced by means of an X-Y displacement using the actuating unit of the focal plane. The readjustment lengths in the X and Y directions are, for example, 10-100 pixel sizes, preferably 40-60 pixels. The optical sensor is, for example, a line or matrix sensor. The pixels, which are preferably square, have for example a pixel length of 5-10 μm. This simplifies the adjustment. A further advantage is that the calibration can be repeated at any time, so that a consistent imaging quality is ensured over the lifetime of the space telescope.

In principle, it is possible to use an image of the Earth or of another object for the calibration.

Preferably, however, the space telescope comprises a test structure which is configured in such a way as to be switchable into the beam path in front of the secondary mirror. In this case, a very wide variety of embodiments are known. For instance, the test structure may be integrated in a shutter, or may be mechanically displaceable. By means of the test structure, one or more defined test patterns that are imaged onto the optical sensor may then be generated.

In a further embodiment, the actuating unit for the focal plane is furthermore configured in such a way as to displace the focal plane additionally in the Z direction.

In a further embodiment, the actuating unit of the focal plane is configured as a piezo-controlled hexapod. In this way, the focal plane can be moved in all six degrees of freedom so that rotations or inclinations of the focal plane, or of the optical sensor, can also be corrected.

In a further embodiment, the actuating unit for the secondary mirror is furthermore configured in such a way that the secondary mirror is displaceable in the X and Y directions. This is advantageous in particular when it cannot be ensured by other measures that the secondary mirror can be displaced in the X and/or Y direction with respect to the primary mirror. Preferably, the actuation length is between 20-100 pixel lengths, although it may also be less.

In a further embodiment, the actuating unit for the secondary mirror is likewise configured as a piezo-controlled hexapod.

The invention will be explained in more detail below with the aid of a preferred exemplary embodiment. The single FIGURE shows a schematic representation of a space telescope.

### BRIEF DESCRIPTION OF THE DRAWING FIGURE

FIG. 1 is a schematic illustration of a space telescope in accordance with the invention.

### DETAILED DESCRIPTION OF THE PREFERRED EMBODIMENTS

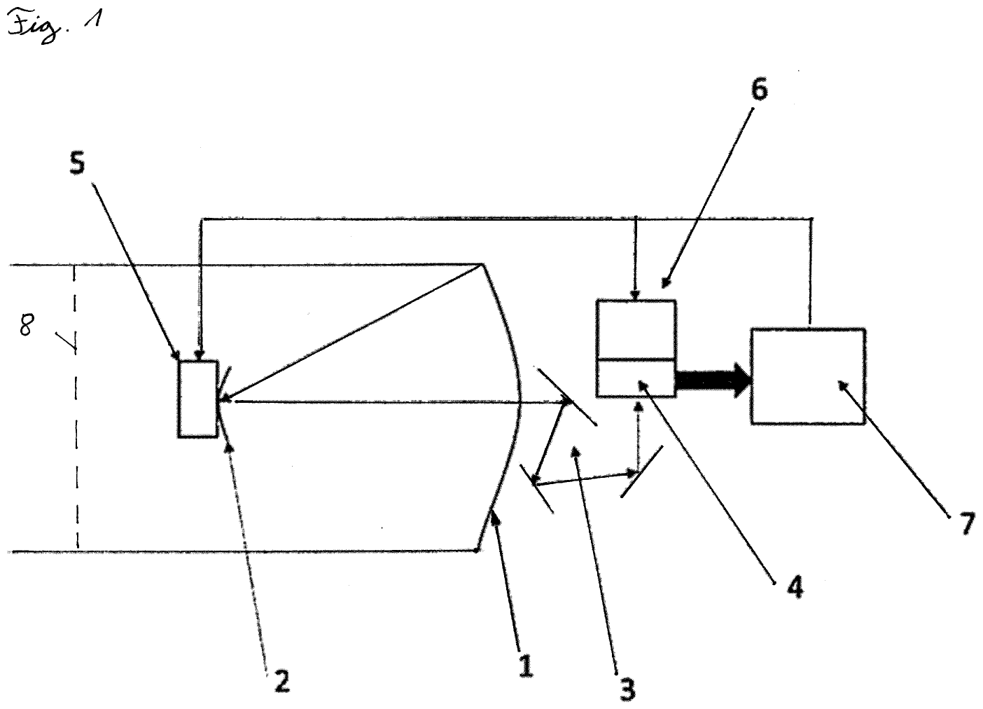

FIG. 1 schematically represents a space telescope 10, which comprises a primary mirror 1, a secondary mirror 2, an image field corrector 3 and a focal plane 4. At least one optical sensor (not represented), which is configured for example as a matrix sensor or as a line sensor (for example a TDI line sensor), is arranged on the focal plane 4. The secondary mirror 2 is assigned an actuating unit 5, by means of which the secondary mirror 2 can be displaced at least in the Z direction, the Z direction being parallel to the optical axis of the space telescope 10. Furthermore, the secondary mirror may in this case additionally be displaceable in the X and Y directions by means of the actuating unit 5. The actuating unit 5 may also be configured as a piezo-controlled hexapod, so that the secondary mirror 2 can be moved in all six degrees of freedom. The focal plane 4 is likewise assigned an actuating unit 6, which is configured in such a way as to displace the focal plane 4 at least in the X and Y directions. The actuating unit 6 is preferably configured as a piezo-controlled hexapod, so that the focal plane 4 can be moved in all six degrees of freedom. The space telescope 10 furthermore comprises an evaluation unit 7, which reads and assesses the data of the at least one optical sensor, the evaluation unit 7 driving the actuating units 5, 6 as a function of the assessment. Lastly, the space telescope 10 also comprises a test structure 8.

The space telescope 10 may be a calibrated, poorly calibrated or even uncalibrated space telescope 10, which is transported in space.

In order to calibrate the space telescope 10, the test structure 8 is then moved into the beam path in front of the secondary mirror 2, or switched on, for example by particular structures of a shutter being rendered transmissive. The incident light is transmitted via the primary mirror 1 onto the secondary mirror 2. The image field is then imaged onto the focal plane 4 with the aid of the image field corrector 3. Image field planarization is in this case carried out by the image field corrector 3. It should in this case be noted that the image field corrector 3 with the three mirrors is only exemplary, and embodiments having only two mirrors are also possible. It should furthermore be noted that the image field corrector 3 may optionally also be omitted. The pixel values of the at least one optical sensor (not represented) are then digitized and assessed in the evaluation unit 7. The data are examined with regard to the fundamental frequencies, and the focus is re-regulated with the aid of the actuating unit 5. To this end, a displacement in the Z direction is carried out, the readjustment ensuring a reproducible adjustment of less than or equal to 1 nm over at least one pixel length. A maximum in the imaging of the optical sensor is in this case sought. If a deviation in the X-Y direction is not precluded by other mechanical provisions, the secondary mirror 2 is additionally displaced in the X and Y directions by the actuating unit 5, the actuation length being for example 50 pixel lengths.

After the focus has been adjusted, the focal plane 4 is displaced in the X and Y directions by means of the actuating unit 6 so that the test pattern is imaged optimally onto the optical sensor. If there has been no success with the readjustment in the spatial frequencies, the focal plane 4 is displaced in the Z direction by permutations in order to obtain the best possible imaging. Subsequently, the imagings in the marginal zones of the optical sensor are compared with those of the center. If they are different, there may be a tilt or rotation of the optical sensor, or of the focal plane 4, in the direction of the trajectory. This may then be tracked by the actuating unit 6 if it is configured as a hexapod. Finally, the symmetry with regard to the spatial frequency is considered. This is adjusted with the aid of the line rate, or the electrical shutter, of the optical sensor. If this has been successful, it is then for example possible to test various TDI stages which should lead to the same spatial frequencies. If this is successful, the space telescope is matched to the orbit, the trajectory and the environmental influences. Drift compensation with regard to the trajectory and AOCS may thus also be carried out with the aid of the actuating device 6.

On the basis of this method, a consistent image quality may be assumed over the lifetime of the space telescope.

During nominal operation, after the initialization described, the digital data in the satellite are transferred to the bulk memory directly or via data compression. The adjustment parameters previously found during the calibration are preferably determined as required before each measurement. If there is consistency with regard to these parameters, they may be defined as standard values and apply until initial abnormalities become apparent.

What is claimed is:

1. A space telescope comprising a primary mirror, a secondary mirror, an image field corrector, a focal plane having at least one optical sensor, and an evaluation unit for the data of the optical sensor,
wherein the focal plane is assigned at least one actuating unit, the at least one actuating unit being configured in such a way as to displace the focal plane in the X and Y directions, the secondary mirror being assigned at least one further actuating unit, which is configured in such a way as to displace the secondary mirror in the Z direction, the actuating unit furthermore being configured in such a way as to ensure a reproducible adjustment of at least 1 nm over at least one pixel length of the optical sensor, the Z direction being parallel to the optical axis of the space telescope.

2. The space telescope as claimed in claim 1, wherein the space telescope comprises a test structure, which is configured in such a way as to be switchable into the beam path in front of the secondary mirror.

3. The space telescope as claimed in claim 1, wherein the actuating unit of the focal plane is furthermore configured in such a way as to displace the focal plane in the Z direction.

4. The space telescope as claimed in claim 1, wherein the actuating unit of the focal plane is configured as a piezo-controlled hexapod.

5. The space telescope as claimed in claim 1, wherein the actuating unit for the secondary mirror is furthermore configured in such a way that the secondary mirror is displaceable in the X and Y directions.

6. The space telescope as claimed in claim 1, wherein the actuating unit of the secondary mirror is configured as a piezo-controlled hexapod.

7. A method for calibrating a space telescope having the features of claim 1 in space, comprising the following method steps:
a) aiming the space telescope at the Earth or generating a test structure in the beam path in front of the secondary mirror,
b) displacing the secondary mirror by means of the control unit of the secondary mirror, the evaluation unit assessing the imaging quality and the actuating unit adjusting the secondary mirror into the Z position with the best imaging quality, and
c) displacing the focal plane in the X and Y directions by the actuating unit, the imaging quality being assessed by the evaluation unit and the X-Y position with the best imaging quality being adjusted by the actuating unit.

8. The method as claimed in claim 7, wherein the marginal zones of the imaging are compared with those of the center, a readjustment of the focal plane in three rotational degrees of freedom being carried out in the event of a deviation, the position with the least deviation being adjusted.

9. The method as claimed in claim 7, wherein a line rate or an electrical shutter of the optical sensor is varied in order to find an adjustment in relation to the best symmetry with regard to the spatial frequencies.

10. The method as claimed in claim 7, wherein the adjustments determined are saved.

11. The space telescope as claimed in claim 2, wherein the actuating unit of the focal plane is furthermore configured in such a way as to displace the focal plane in the Z direction.

12. The space telescope as claimed in claim 3, wherein the actuating unit of the focal plane is configured as a piezo-controlled hexapod.

13. The space telescope as claimed in claim 4, wherein the actuating unit for the secondary mirror is furthermore configured in such a way that the secondary mirror is displaceable in the X and Y directions.

14. The space telescope as claimed in claim 11, wherein the actuating unit of the focal plane is configured as a piezo-controlled hexapod;

15. The space telescope as claimed in claim 14, wherein the actuating unit for the secondary mirror is furthermore configured in such a way that the secondary mirror is displaceable in the X and Y directions.

16. The space telescope as claimed in claim 2, wherein the actuating unit of the secondary mirror is configured as a piezo-controlled hexapod.

17. The space telescope as claimed in claim 16, wherein the actuating unit of the focal plane is furthermore configured in such a way as to displace the focal plane in the Z direction.

18. The method as claimed in claim 8, wherein a line rate or an electrical shutter of the optical sensor is varied in order to find an adjustment in relation to the best symmetry with regard to the spatial frequencies.

19. The method as claimed in claim 8, wherein the adjustments determined are saved.

20. The method as claimed in claim 9, wherein the adjustments determined are saved.
